(19) United States
(12) Patent Application Publication
(10) Pub. No.: US 2004/0238626 A1
(43) Pub. Date: Dec. 2, 2004

(54) Sales device for multimedia productions

(75) Inventor: Martin Salzmann, Lubeck (DE)

Correspondence Address: COHEN, PONTANI, LIEBERMAN & PAVANE, 551 FIFTH AVENUE, SUITE 1210, NEW YORK, NY, 10176, US

(73) Assignee: Franz Maurer Nachf. GmbH & Co. KG

(21) Appl. No.: 10/814,941

(22) Filed: Mar. 31, 2004

(30) Foreign Application Priority Data
May 26, 2003 (EP) 03 011 812.9

(51) Int. Cl. G06F 7/08

(52) U.S. Cl. 235/381

(57) ABSTRACT

A sales device for selling multimedia productions in digital file form includes at least one computer unit to which one or more data memories are allocated. Multimedia productions are stored in file form in the data memories. The sales device includes at least one selection terminal at which the production may be at least partly displayed or played and one or more productions may be selected. The selection of multimedia productions may be displayed at the selection terminal. Furthermore, an issue unit issues the selected multimedia productions in file form or stores them on a data carrier.

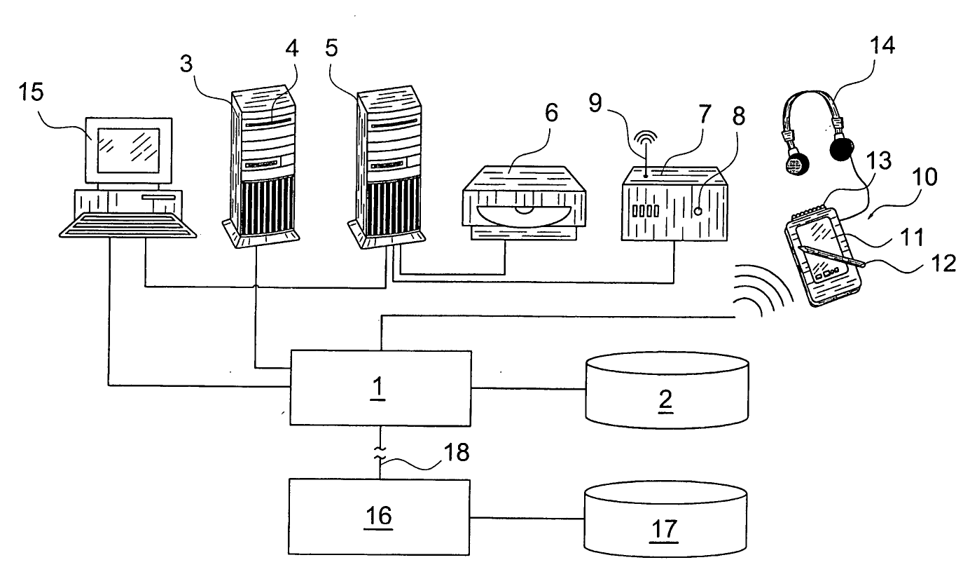

### BACKGROUND OF THE INVENTION

1. Field of the Invention

The invention relates to a sales device for the sale of multimedia productions in digital form.

2. Description of the Related Art

Multimedia productions in digital form such as, for example, printed productions (e.g., books and articles), music productions (e.g., operas, musicals or songs), or film productions (e.g., films or film clips provided with music), and other productions such as computer games, are currently marketed on data carriers. In recent years, CDs and DVDs have proven their worth as data carriers. However, data carriers which may be scanned in a movement-free manner such as memory cards and UBS-sticks may also be used to store such data.

A problem with these ready manufactured data carriers is the fact that when the customer only wishes to purchase a few productions, the customer must always purchase a number of productions which are stored together in digital form on a mass-produced data carrier.

In the field of music productions, marketing forms have been established with which individual music titles may be downloaded from the Internet with or without payment. These forms of marketing on the one hand however have the disadvantage that one requires a rapid Internet access, typically a DSL access, is required to download the files within a reasonable time, and on the other hand the user needs to obtain suitable hardware and software to store these files on a data carrier which may be played in several apparatus, in particular to burn it onto a CD or DVD.

To simplify the selection when purchasing music CDs, British patent document GB 2 353 135 discloses a system in which listening samples of the CDs offered in a shop are stored onto a data memory. The listening samples are controlled by a computer and are available at so-called listening terminals. The listening terminals comprise a bar code reader. A customer wishing to listen to the listening samples associated with a particular CD holds the CD sleeve so that the bar code reader detects the bar code attached to the CD sleeve. The computer locates the title of the CD allocated to this bar code and makes the listening samples associated with the CD available to the listening terminal. The customer in the shop may then purchase the industrially manufactured data carrier (i.e., CD) or not. With this known system too, one may only offer and trade with ready-manufactured data carriers. A further disadvantage lies in the fact that the CD sleeves to be scanned must be brought to the listening terminal, where they are often left and then must be resorted by the staff in a cost-intensive manner.

### SUMMARY OF THE INVENTION

Against this background, it is the object of the invention to provide a sales device which avoids the previously mentioned disadvantages and permits the customer, after a suitable selection, to purchase only the multimedia productions in the form of digital files which the customer indeed wishes to purchase.

The object of the present invention is achieved by a sales device with which the customer in a simple and inexpensive manner may compose the multimedia productions such as, for example, music titles, film titles, book titles or computer games, and have these productions issued on any data carrier or without a data carrier, without at the same time being restricted to the industrially manufactured production compositions. The sales device according to the present invention is suitable for the selection and for the sale of multimedia productions of any type in digital file form. However, the following description of the present invention outlines the function and advantages of the sales device using music productions. It is to be understood that, in a corresponding manner, one may also sell other multimedia productions with such a device, and that a mixed issue, for example printed productions, film productions and music productions is also possible.

The sales device according to the invention comprises at least one computer unit, typically a server, to which there are allocated one or more data carriers, for example in the form of hard disks on which the previously mentioned multimedia productions have been digitally stored, in each case in file form. To this computer unit there is allocated at least one, as a rule however a plurality of selection terminals at which the multimedia productions provided for sale may at least be partly displayed or played and at which one or more multimedia productions may be selected. The selection of productions made at a selection terminal is indicated or displayed here so that the user at any point in time may ascertain which productions he has already selected. Furthermore the sales device comprises an issue unit which issues the selected productions in file form after completion of the selection or after reaching a predefined data quantity. The issuing may at the same time may be effected as a pure data output or onto a data carrier envisaged to be taken away by the customer, typically in a manner such that selected productions in file form may be burnt onto a CD or DVD.

The sales device according to the present invention combines the advantage of purchasing individual music titles in digital form after individual selection, which is otherwise only known from Internet trading with the advantages of conventional trading with which the files are already stored on a data carrier, which may be read in commercially available apparatus, be it a permanent memory or a CD or DVD.

The sales device according to the present invention may operate with a selection terminal with which individual artists or titles may be selected by keyboard input, track ball or touch-screen from a predefined list via various menu levels on the display. The sales device according to the present invention preferably functions with a stationary or mobile selection terminal which contains or is allocated to a scanner. The scanner is preferably a bar code scanner. The scanner detects a picture or barcode of the CD that the customer is interested in and a computer connected to the scanner and selection terminal carries out the individual or grouped allocation of productions depending on the picture or bar code detected by the scanner and displays this at the selection terminal. Typically a selection terminal formed in this manner uses the bar code attached to the CD sleeves for identification. The computer manages or controls a data bank which comprises the data of the CD associated with the bar code read by the scanner. The data may, for example, include titles and producer/singer as well as title details on the individual tracks. The data is displayed at the selection terminal and/or corresponding listening samples are provided at the selection terminal. At the listening terminal, the individual tracks of the CD which are displayed in the display of the terminal may first be selected as a listening sample and then, where appropriate, be selected for purchase, i.e. for the later issuing in file form on a data carrier or in another manner. This may for example be effected in that the pieces for the listening sample are first marked with a button by a scroll function for the listening sample and with another button for the purchase selection, wherein usefully for each type of selection the title is provided with a suitable indication.

The selection terminal may comprise a small computer operated, for example, by a battery and which is in data connection with the computer unit such as, for example, by radio. The selection terminal may also comprise a display, a loudspeaker and a headphones output as well as means for data input and the scanner. Such small computers may be modified hand-held computers or PDA's. Multimedia productions of all types may be represented at the selection terminal via the display and the loudspeaker or the headphones output, be it in the form of a reader sample which is displayed on the display, a piece of music which may be listened to via the loudspeaker or headphones or a video clip whose picture additionally appears on the display. A corresponding representation of computer games is likewise possible.

A wireless data connection between the selection terminal and the computer unit is particularly advantageous since with this arrangement the customer does not need to go to the selection terminal with the selected CD sleeves, but may immediately make the selection specifically where the CD is. This relieves the customer density in the region of the selection terminal. Furthermore, this also reduces the number of CDs which must be sorted again in comparison to known systems or that only CD sleeves need to be attached, where appropriate even in a stationary manner. Thus it may be envisaged that instead of displaying the CD sleeves, a store may set up displays which show a multitude of such CD covers or titles so that, as the case may be, it is no longer necessary to exhibit original products in the shop or to stock a supply which requires capital. In the same manner book titles or film titles may be imaged. Instead of a bar code, the title or the graphic representation is scanned and thus the allocation to the corresponding productions or groups of productions which is required with respect to the databank is effected.

Any system may be applied as a payment system with the sales device according to the invention. It is, however, useful to provide a billing terminal with which the sales personnel or, where appropriate, the device itself may create a bill depending on the selection of productions, ascertain the completion of bill payment, and emit a signal which releases the output of data to the issue unit. In this manner it may be ensured that the data issuance is effected only when the payment has already been effected. The terms “bill” and “bill payment” in the context of the present invention is not to be understood as an accounting bill, but merely a measure which ascertains an amount of the bill or its payment or possibility for payment, be it by way of an account or by way of cash.

To permit a data issue in a commercially available CD or DVD, the issue unit usefully comprises a suitable burner as well as a printer with which either the data carrier is directly inscribed or also a label which may be attached onto the data carrier or its packaging is printed out. Alternatively, the issue unit may also comprise a device for the automatic manufacture of inscribed data carriers, in particular CDs or DVDs, a so-called CD or DVD burner robot which in an automatic manner performs the working steps from supplying the blank up to issuing the completely inscribed data carrier provided with data.

In a further embodiment of the invention, the data issue need not necessarily be carried out on a conventional sound recording device but may be transmitted directly into a memory of an apparatus for playing digital media such as, for example, an MP3 player. In this embodiment, the issue unit comprises an interface for the data issue. The interface may comprise a USB, Fire Wire or other type of interface. In a preferred embodiment, the interface is a wireless interface, such as an IR interface or a Blue-Tooth interface. As an alternative, a wireless-LAN interface may also be provided here. In this manner the files may then be wirelessly transmitted onto the apparatus which is brought by the customer. The files may also be supplied to the customer by e-mail or in the form of downloads.

Present sales systems are essentially based on industrially manufactured data carriers. Accordingly, it is useful for the sales system of the present invention to be able to record new titles in the sales device, to provide a data input unit for acquiring the productions and their titles and where appropriate further data. For example, the data input unit may be a suitable drive for CDs and DVDs. This drive reads out the data stored on the CD or DVD and transmits the read data into the data bank of the sales device. Where appropriate also a scanner and/or a keyboard may be allocated to the data input unit to detect the title and/or cover or bar code.

Basically it is useful if this data is accordingly processed by the music industry and then for example is transmitted via a data cable or an Internet connection to a central server connected before being transmitted or distributed to the sales device.

The sales device according to the invention is typically designed for shops which sell today's industrially manufactured CDs and DVDs. Since a multitude of shops may be equipped with such sales devices and the data quantities to be managed however are extremely large, the data may be centrally stored and connected to a local computer by a data connection, in particular an Internet connection, in which only a part of this data is stored. The local computer unit may, when required, request data from a central server. Alternatively, a data exchange may be effected periodically. With such a set-up the equipment with respect to hardware of the sales device present in every shop may be considerably simplified. Furthermore this embodiment also permits small shops to have a comparatively large sales choice. The computer unit according to the present invention which is to be formed by several computers is not only advantageous with respect to the speed of availability, but furthermore permits the hardware costs to be kept low. At the same time the several computers, inasmuch as they are spatially connected to one another, may be in data connection via a network or, with greater distances, preferably via the Internet.

To keep the amount of data to be stored as low as possible, the multimedia productions present in digital file format may be stored in compressed form, music files preferably in the MP3 format, video files in the MPEG4 format, book files in E-book or PDF format. The data issue is however effected selectively in compressed form or non-compressed form. By suitable conversion program thus according to the desires of the customer one may also issue the music file stored in MP3 format in wave format so that this may be played on a common CD player. It is to be understood that the compressing method is selected such that a high quality level remains intact.

To limit the data to be transmitted between the computer unit and the selection terminal with respect to quantity, each production is stored completely as a file and additionally in the form of a clip of the production as an additional file. Alternatively, the computer unit may output the clip portion to the selection unit. Such an additional file thus forms a listening sample which is preferably transmitted in a wireless manner to the selection unit on selection with regard to the purchase decision.

The sales device according to the present invention may, as described previously, be applied in a usual shop with a set-up surface, cashier system and suitably trained personnel. However according to a further embodiment, the sales device may be configured for fully automatic operation such as, for example, in self-service shops in gas stations, travel rest stops, and other areas, where trained personnel are not available. The sales device is then usefully arranged in an essentially closed housing, wherein the selection unit comprises a touch-screen preferably accessible from the outside, or a display with a keyboard or other input means, and the cashier terminal comprises a money and/or credit card read apparatus as well as a money receiving and evaluation means. The customer then at the automatic machine may himself select the title of interest to him on the display by the touch-screen or the additional input means and listen to this title where appropriate in the form of a listening sample. The customer may then make his choice and, after a corresponding insertion of money or introduction of his credit card into the apparatus, activate the data issue, which may be effected using the previously mentioned interfaces or in the form of a data carrier (CD, DVD, or other data carrier).

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is hereinafter described in more detail by way of an embodiment example shown in the drawing. The sole Figure is a schematic block diagram showing a sales device according to the present invention.

### DETAILED DESCRIPTION OF THE PRESENTLY PREFERRED EMBODIMENTS

The sales device shown in the Figure includes a computer unit 1 in the form of a server to which there is allocated a data memory 2. Databank software on the server manages digital files comprising multimedia productions (e.g. music tracks or pieces of music) stored in the data memory 2. The sales device shown here is designed for the sale of pieces of music which are stored in the data memory 2 in the form of MP3 files. Furthermore, the data-bank program allocates or associates the digital files with information printed on a CD sleeve or on a CD label. This information in particular comprises the bar code, the title, the artist, and the producer of the CD as well as the title of the individual pieces of music. In addition, the data memory 2 stores a listening sample for each multimedia production, i.e., each file stored in MP3 format. The listening sample comprises a clip of approximately 30 seconds of the respective production which may also be stored in MP3 format. These listening sample files typically have a greater degree of compression than the file having the complete production or the complete track (piece of music).

A data input unit 3 in the form of a PC is connected to input the digital files of the multimedia productions into the sales device. The data input unit 3 comprises a DVD drive 4, an output device such as a display (not shown) and input devices such as a keyboard as well as a scanner or bar code scanner. A music CD is read by the data input unit 3. The music CD stores one or more wave files. At the same time each individual wave file is converted into an MP3 file, transferred to the server 1 which manages the MP3 file and stores it in the data memory 2 using the data bank program. The associated data such as the title, producer and title of the individual tracks (pieces of music) may either be inputted via the keyboard or may be read in via the scanner, or a combination of the two. The data input unit 3 is connected to the server 1 via a common network connection.

An issue unit 5 is arranged for issuing the files to a customer. The issue unit 5 is in the form of a PC which activates a CD burner 6 with an inscription unit, as well as an interface unit 7. Furthermore a printer (not shown) is also allocated to the issue unit 5. After a customer chooses particular pieces of music (described in more detail further below), a number of MP3 files with the associated data is issued by the issue unit 5 onto a data carrier, here, in particular a CD. The data is recorded in a format specified by the customer such as, for example, MP3 but also converted again into the wave format. This CD at the same time is also inscribed by way of the inscription unit, and specifically with the titles of the tracks as well as the artists.

At the same time a sticker for the cover is created by a printer. The sticker displays the title of the pieces of music burnt individually in file form on the CD in the sequence in which they are stored on the CD. Alternatively, a corresponding cover for a CD sleeve with the previously mentioned details may be printed out. This is all controlled by the computer of the issue unit 5.

An interface unit 7 is provided for the customers who desire the files to be transferred directly to an apparatus brought along by the customer, such as an MP3 player, instead of having the files transferred to a data carrier such as a CD. The interface unit 7 comprises a USB and a Fire Wire interface via which the customer apparatus may be connected by a cable for receiving the data outputted by the issue unit 5. The interface unit may furthermore be provided with a LAN connection. The interface unit 7 may additionally or alternatively further comprise an infrared interface 8, a Blue-Tooth interface 9, and a radio-supported interface, specifically a wireless-LAN. Accordingly, a wireless data output may be effected by the interface unit 7 for file transfer to the customer, in each case with the application of the essentially standardized protocols. The files transmitted to a suitable reproduction apparatus also contain the file descriptions important to the customer such as artist and title.

An essential component of the sales device according to the invention are selection units in the form of terminals 10 of which one is shown by way of example in the figure. The selection terminal 10 is a microcomputer in the form of a modified handheld which is data-connected to the server 1 by a standardized radio interface (wireless LAN). The shown selection terminal comprises a touch-screen 11 which may be controlled with a finger or preferably with a pen 12. Instead of a touch-screen 11, a display with suitable control buttons may alternatively be provided. One end face of the selection terminal 10 includes a bar code laser 13 as a scanner. A headphone set 14 is connected to the selection terminal 10.

The selection terminal 10 is made available to the customer for allowing the customer to select pieces of music to be purchased. With the selection terminal, the customer goes through the shop and makes a first selection by looking at the CD sleeves or CDs which are exhibited. If the customer likes or is interested in a title of such a CD sleeve, the bar code arranged on the rear side (or other location) on the CD sleeve is scanned by the bar code reader 13. The scanning may be effected by activating a corresponding button at the selection terminal 10 or activating the touch screen 11 at the suitable location. The scanned data is then transmitted via radio interface to the server 1 where it is processed. Then corresponding listening samples as well as the associated title of the individual pieces of music of the CD whose bar code has been read are transmitted to the selection terminal 10. All titles/tracks of this CD are then displayed on the display below one another, wherein there is provided a scroll function, in the case that more titles are on the CD than the display may accommodate. Individual titles may then be selected as a listening sample, whereupon a playing of this title for approximately 30 seconds is available at the headphone set 14. Independently of the selection of listening samples, the titles on the display may be selected directly for purchase. This selection data is stored in the issue unit 5 as well as transmitted to the server 1. A sub-level of the operating menu allows the already selected titles to be displayed on the display at any time. Another sub-level of the operating menu allows the selection to be effected without the prior scanning of CDs if a corresponding alphanumeric input according to title and producer is effected. To perform the selection without scanning, the selection terminal 10 is connected to the data bank managed in the server. Only the listening samples are stored within the selection terminal 10 in each case which have been transmitted with the last scanning procedure or which have been requested by the alphanumeric input. On newly activating the scanning procedure, the previously stored listening samples are automatically written over.

As soon as the customer has completed his selection or the selection has reached a predefined data quantity which has reached a predefined data volume, typically that of a CD, the customer inputs a selection end command using the selection terminal 10 which is transmitted to the server 1. MP3 files are composed by the server 1 according to the selected titles and this data is transferred to a billing terminal 15 in which the purchase price is determined and a corresponding bill is set up for the customer. The billing terminal 15 may comprise a common cashier system with which the payment may also be effected with or without cash. As soon as payment has been effected, the data is transmitted to the issue unit 5 from the billing terminal 15. Alternatively the issue unit 5 may also be directly connected to the server 1 such that the billing terminal generates and transmits only a release signal which frees the data for issue after the billing and payment has been effected. The issue unit 5 then selectively creates a CD using a CD burner 6 incorporating the pieces of music which the customer has previously selected, wherein the file format in which the files are stored on the CD may be specified previously by the customer using the selection terminal 10. Alternatively or additionally, the issuing of the data may also be effected via the interface unit 7 directly to an apparatus which is to be specified by the customer.

If a plurality of sales devices are installed in shops at various locations, then it is useful to provide a central server 16 with a data memory 17 separate from the server 1 located in the shop with the data memory 2. Then all data of the system may be stored, managed and updated via the central server 16. Then either periodically or when required a comparison of the databanks may be effected via an Internet connection 18 or other data connection.

With music files, in particular however with film files, enormous memory capacity resources are required to realize a wide sales choice. To economically use the resources, it does not make economic sense to provide a data memory 2 in every shop which contains all data (all available pieces of music or videos). This is more efficiently stored on the central server 16 using the data memory 17. In the data memory 2 preferably the most common titles or all listening samples are stored so that when required, if the customer should select a title which is not available on the data memory 2, it may be transmitted practically simultaneously via the Internet connection 18 from the central server, thus from the data memory 17.

The above mentioned components, their number, their connection to one another, and the connection of the servers amongst one another has been described only by way of example. They may however also be realized in another suitable manner as would appear useful with regard to up-to-date technical standards. Their interfaces and memory media mentioned by way of example here are not limited to the devices mentioned, which are to be understood merely as examples. They may be adapted in any manner to the respective technical standard.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A sales device for selling multimedia productions in digital format, the multimedia productions comprising at least one of printed productions, music productions, film productions, and computer games, the sales device comprising:
a computer unit and a data memory allocated to said computer unit, the data memory storing multimedia productions in digital file format;
at least one selection terminal connected to said computer unit including means for displaying or playing at least portions of the multimedia productions, the at least one selection terminal further comprising means for receiving an input from a user for selecting selected ones of the multimedia productions and indicating the selected ones of the multimedia productions to the user; and
an issue unit for selectively issuing a data output of the selected ones of the multimedia productions, said data output comprising the selected ones of the multimedia productions in a form comprising one of a digital file form and in a form stored on a data carrier.

2. The sales device of claim 1, wherein the selection terminal further comprises a scanner for scanning one of pictures and barcodes of multimedia packages and said computer unit comprises means for performing an individual or grouped allocation of the multimedia productions in response to the one of a picture and a bar code detected by said scanner and displaying the allocated productions at the selection terminal.

3. The sales device of claim 2, wherein said scanner comprises a bar code scanner.

4. The sales device of claim 1, wherein said selection terminal is a small computer in data connection with said computer unit and which comprises a display, an audio output device, a user input device and a scanner for scanning one of pictures and barcodes of multimedia packages.

5. The sales device of claim 4, wherein said selection terminal is connected to said computer unit by a radio connection.

6. The sales device of claim 1, further comprising a billing terminal connected to said computer unit for creating a bill for the selected ones of the multimedia productions and for emitting a signal to the issue unit for releasing the data output including the selected ones of the multimedia productions from the computer unit to the issue unit after completion of the payment of the bill.

7. The sales device of claim 1, wherein said issue unit comprises a device for the automatic manufacture of inscribed data carriers containing the selected ones of the multimedia productions.

8. The sales device of claim 7, wherein said issue unit comprises a printer and one of a DVD burner and a CD burner.

9. The sales device of claim 1, wherein said issue unit comprises an interface for transmitting the data output in digital file form.

10. The sales device of claim 9, wherein said interface comprises a wireless interface comprising one of an IR interface, a Blue-Tooth interface and a wireless LAN-interface.

11. The sales device claim 1, further comprising a data input unit for receiving and recording new multimedia productions and associated information for storage in said data memory.

12. The sales device of claim 1, wherein said computer unit comprises a plurality of computers data-connected by a communication network.

13. The sales device of claim 1, further comprising a central server for managing files containing multimedia productions using databank software, said central server being connected to said computer unit and at least another data server by a data connection for providing data to said computer unit and said at least another data server, wherein said computer unit and said at least another data server manage only a part of the data stored in said central server.

14. The sales device of claim 1, wherein the multimedia productions are stored in compressed format, and wherein the data issue is effected selectively in one of a compressed format and a format converted into another format.

15. The sales device of claim 1, wherein each multimedia production is stored completely as a file and additionally in the form of a clip of the multimedia production as an additional file.

16. The sales device of claim 1, wherein each multimedia production is stored completely as a file and is selectively outputted to said selection unit as a clip of said each multimedia production.

17. The sales device of claim 6, wherein said sales device is arranged in an essentially closed housing, said selection unit is accessible from the outside of said closed housing, and said billing terminal comprises at least one of a money receiving and evaluation unit and a credit card reading apparatus.

18. The sales device of claim 17, wherein said selection unit includes one of a touch-screen and a display with a keyboard.
